(19) United States
(12) Patent Application Publication
(10) Pub. No.: US 2005/0053540 A1
(43) Pub. Date: Mar. 10, 2005

(54) Method for producing amorphous silicon and/or organohalosilanes produced therefrom

(76) Inventor: Norbert Auner, Taunus (DE)

Correspondence Address: BROOKS KUSHMAN P.C., 1000 TOWN CENTER, TWENTY-SECOND FLOOR, SOUTHFIELD, MI, 48075, US

(21) Appl. No.: 10/501,369

(22) PCT Filed: Jan. 17, 2003
(86) PCT No.: PCT/DE03/00116

(30) Foreign Application Priority Data
Jan. 18, 2002 (DE) 102-01-772.7
Apr. 17, 2002 (DE) 102-17-125.4
Apr. 17, 2002 (DE) 102-17-140.8
Apr. 17, 2002 (DE) 102-17-124.6
Apr. 17, 2002 (DE) 102-17-126.2

(51) Int. Cl. C01B 33/033

(52) U.S. Cl. 423/350

(57) ABSTRACT

Highly pure and reactive amorphous silicon metal particles are prepared in an organic solvent by reducing a halosilane, organohalosilane, or salt thereof with a metal reducing agent. When the halogen is other than fluorine, and apolar organic solvent is employed. Numerous silicon-containing reactant sources may be used, and the process may be used thusly to purify silicon, or to prepare an amorphous silicon intermediate which can react with organohalogen compounds at low temperatures to produce organosilicon compounds such as methylhalosilanes.

The present invention relates to a process for preparing amorphous silicon and/or organohalosilanes obtained therefrom.

It is an object of the invention to provide a process of the type specified, which can be carried out with a particularly low demand for materials and/or energy, and/or features particularly high versatility.

In a first variant of the process according to the invention, the invention relates to a process for preparing amorphous silicon by reducing a halosilane with a metal in a solvent.

Such a process is known. For example, WO 0114250 describes a process for preparing silicon nanoparticles, in which, in a first step, a halosilane is reduced with a metal in a solvent in order to form a first reaction mixture which comprises a metal halide, amorphous silicon and halogenated silicon nanoparticles. Since the amorphous silicon is obtained as a by-product in this process, details thereof are not described. Rather, the object of working up this first reaction mixture in three further process steps is to recover the silicon nanoparticles.

The solvents proposed are various types of glycol ethers, possibly in a mixture with an apolar solvent.

Amorphous refers to solids whose molecular building blocks are not in crystal lattices, but rather arranged randomly. Amorphous silicon (a-Si) can be prepared substantially less expensively than crystalline silicon and thus constitutes a material for which there is a great demand.

According to the invention, the object specified is achieved in a process of the above type by using an apolar solvent as the solvent.

It is also possible by the process according to the invention to obtain amorphous silicon which, in comparison to amorphous silicon prepared in a conventional manner, has increased reactivity.

The term “solvent” used here means a medium which is capable of preparing a dispersion of the metal in the “solvent”, i.e. this term is also intended to include simple dispersions. An “apolar or nonpolar” solvent has no polar groups or functional groups whose characteristic electron distributions impart to the molecule a considerable electrical dipolar moment, so that such groups bring about the affinity for other polar chemical compounds.

It has been found in accordance with the invention that use of an apolar solvent in the above-specified reduction process provides pure amorphous silicon which has a black color. This amorphous silicon is not “surface-coated” and features particularly high reactivity. This is in contrast to the amorphous silicon obtained in a conventional manner which occurs as a brown powder and, as investigations have shown is “surface-coated”, for example with Cl, silyl chloride or O₂ or HO.

The preparation processes hitherto have always worked with polar solvents which have inevitably led to a surface coating of the silicon obtained, which was designated as “amorphous”, but in reality was not pure amorphous silicon owing to the surface coating present. For instance, the process in the abovementioned publication also works with a polar solvent (glycol ether).

Organic, noncoordinating solvents such as xylene, toluene preferably find use.

The metal used is preferably a metal of group I or II of the Periodic Table. Sodium is preferred, but good results have also been achieved with magnesium.

The halosilane used is preferably a silane of Br, Cl, I or F, or an organosilane of Br, Cl, I or F. The halosilane used is more preferably a silicon tetrahalide, and especially silicon tetrachloride (SiCl₄) or silicon tetrafluoride (SiF₄) find use.

The metal is preferably melted in the solvent in order to produce a dispersion of the metal in the solvent. Such a melting is not absolutely necessary, but rather metal dusts, metal powder, etc may also be used. It is essential that the metal is in a state having a surface activated for the reaction.

When the metal is to be melted in the solvent, an apolar solvent preferably finds use, whose boiling point is higher than the melting point of the metal used, and operation is affected with a reaction temperature above the melting temperature of the metal (sodium=96° C.) and below the boiling point of the apolar solvent used. It is also possible to work at elevated pressures.

Appropriately, the process according to the invention is carried out under reflux conditions for the solvent.

In the process according to the invention, the uncoated amorphous silicon is obtained in a mixture with a metal halide. Even this mixture, relative to the amorphous silicon, has a very high reactivity, so that it can be used for the desired further reactions. However, the amorphous silicon may also be isolated from the mixture by a separating process, for which any physical or chemical separating processes may be used. For example, physical separating processes such as melting, pressing, centrifuging, sedimentation processes, flotation processes, etc. may be used. The chemical process carried out may be an extractive washing of the amorphous silicon with a solvent mixture which dissolves the metal halide but does not react irreversibly with the silicon. For example, liquid ammonia is used to obtain silicon coated with ammonia, and the desired pure amorphous silicon having a black color can be prepared by pumping off the ammonia.

In a further variant of the process according to the invention, the invention relates to a process for preparing organohalosilanes, especially methylchlorosilanes, by reacting silicon and organohalogens.

Of the organohalosilanes, the methylchlorosilanes are of particularly great significance, since they are starting products for the preparation of silicones. These are a group of chlorinated organosilicon compounds, for example trichloromethylsilane H₃CSiCl₃, dichlorodimethylsilane (H₃C)₂SiCl₂ and chlorotrimethylsilane (H₃C)₃SiCl. The methylchlorosilanes are colorless, pungent-smelling liquids which fume vigorously under air owing to HCl release, which hydrolyze with water and subsequently form condensation products.

Methylchlorosilanes are formed using Cu as a catalyst in the reaction of finely ground Si with methyl chloride at approx. 300° C. in fluidized bed reactors (Müller-Rochow synthesis). This provides a mixture of methylchlorosilanes which is separated into the individual constituents by fractional distillation. The synthesis of the chlorophenylsilanes from Si and chlorobenzene in the presence of Cu or Ag proceeds in the same way in principle.

Organohalosilanes can therefore be prepared at relatively moderate temperatures (around 300° C.) only with the aid of catalysts, of which examples are Cu or Ag. A preparation without catalysts is only possible at temperatures above 1200° C.

The object outlined at the outset is achieved in this process variant by a process for preparing organohalosilanes, especially methylchlorosilanes, by reacting silicon and organohalogens, by reacting amorphous silicon with the organohalogen.

The process according to the invention offers the advantage that the reaction of the amorphous silicon with the organohalogen proceeds at lower temperatures than in the prior art. A further advantage is that the process can be carried out without catalyst, and at temperatures which are below the reaction temperatures known hitherto (about 1200° C.). However, the process may also be carried out using a catalyst, for example Cu or Ag, in which case the reaction may be carried out at temperatures of <300° C. The advantage over the known Müller-Rochow synthesis is thus the saving of catalyst material and/or the saving of energy.

The advantages, outlined at the outset, of the process according to the invention are based on the use of amorphous silicon.

Amorphous refers to solids whose molecular building blocks are not arranged in crystal lattices, but rather randomly. Amorphous silicon (a-Si) can be prepared substantially less expensively than crystalline silicon, and thus constitutes a material for which there exists a great demand. The amorphous silicon obtained hitherto in a conventional manner, as investigations have shown, is contaminated to a greater or lesser extent, since it is “surface-coated”, for example with Cl, silyl chloride or O₂ or HO. This material is obtained as a brown powder. It is suitable for the process according to the invention.

In contrast, a novel process has been used to prepare amorphous silicon with high purity, which has a black color. This amorphous silicon is not “surface-coated” and features a particularly high reactivity. When this black amorphous (uncoated) silicon is now reacted with the organohalogen, it is possible in this way to prepare organohalosilanes at particularly low temperatures and/or without catalyst, since the black amorphous silicon features particularly high reactivity.

The black amorphous (uncoated) silicon used in accordance with the invention is, for example, prepared by reaction of a halosilane with a metal in a solvent, and the solvent used is an apolar (nonpolar) solvent. The term “solvent” used here means a medium which is capable of preparing a dispersion of the metal in the “solvent”, i.e. this term is also intended to include simple dispersions. An “apolar or nonpolar” solvent has no polar groups or functional groups whose characteristic electron distributions impart to the molecules a considerable electrical dipolar moment, so that such groups bring about the affinity for other polar chemical compounds.

The use of an apolar solvent in the above-specified reduction process provides pure amorphous silicon which has a black color. The preparation processes hitherto have always worked with polar solvents which have inevitably led to surface coating of the silicon obtained, which has been designated as “amorphous”, but in reality has not been pure amorphous silicon owing to the surface coating present.

Organic, noncoordinating solvents such as xylene, toluene preferably find use.

The metal used is preferably a metal of group I or II of the Periodic Table. Sodium is preferred, but good results have also been achieved with magnesium.

The halosilane used is preferably a silane of Br, Cl, I or F, or an organosilane of Br, Cl, I or F. The halosilane used is more preferably a silicon tetrahalide, and especially silicon tetrachloride (SiCl₄) or silicon tetrafluoride (SiF₄) find use.

The metal is preferably melted in the solvent in order to produce a dispersion of the metal in the solvent. Such a melting is not absolutely necessary, but rather metal dusts, metal powder, etc may also be used. It is essential that the metal is in a state having a surface activated for the reaction.

When the metal is to be melted in the solvent, an apolar solvent preferably finds use, whose boiling point is higher than the melting point of the metal used, and operation is affected with a reaction temperature above the melting temperature of the metal (sodium=96° C.) and below the boiling point of the apolar solvent used. It is also possible to work at elevated pressures.

Appropriately, the process according to the invention is carried out under reflux conditions for the solvent.

In the above-described process for preparing black amorphous silicon, the uncoated amorphous silicon is obtained in a mixture with a metal halide. Even this mixture, relative to the amorphous silicon, has a very high reactivity, so that it can be used for reaction with the organohalogen. However, the amorphous silicon may also be isolated from the mixture by a separating process, for which any physical or chemical separating processes may be used. For example, physical separating processes such as melting, pressing, centrifuging, sedimentation processes, flotation processes, etc. may be used. The chemical process carried out may be an extractive washing of the amorphous silicon with a solvent or solvent mixture which dissolves the metal halide but does not react irreversibly with the silicon. For example, liquid ammonia is used to obtain silicon coated with ammonia, and the desired pure amorphous silicon having a black color can be prepared by pumping off the ammonia.

In the process according to the invention for preparing organohalosilanes, it is possible, in a similar manner to the Müller-Rochow synthesis, to use the black amorphous silicon as a fine, especially nondusting, silicon powder and to carry out the reaction in a fluidized bed.

As already mentioned, the process according to the invention proceeds at elevated temperatures which, however, owing to the high reactivity of the amorphous silicon, are lower than in the prior art. These elevated temperatures may be attained by heating in a customary manner. However, a further embodiment of the process according to the invention provides that the reaction of the amorphous silicon with the organohalogen is brought about by microwave energy. In this case, the reaction may be carried out with or without catalyst.

In a particularly preferred variant, the amorphous silicon is used in conjunction with a substance which absorbs microwave energy and transfers thermal energy to silicon. This substance may simultaneously act as a catalyst/promoter. An example of such a substance is copper.

So that the reaction proceeds continuously, preference is given to using nonpulsed microwave energy. To generate the desired microwave energy, it is possible to use known microwave ovens.

In a third variant of the process according to the invention, the object specified at the outset is achieved by a process for preparing amorphous silicon, which has the following steps:

Obtaining silicon tetrachloride (SiCl₄) by
a. reacting SiO₂ with chlorine in the presence of a reducing agent,
ab. reacting silicon with chlorine or chlorine compounds, or
ac. obtaining the SiCl₄ as a by-product of the Müller-Rochow synthesis or of the preparation of chlorosilanes, and
b. reducing the silicon tetrachloride (SiCl₄) with a metal in a solvent.

The process according to the invention thus features two steps, in which silicon tetrachloride is prepared or obtained in the first step. In the second step, the silicon tetrachloride is reduced with a metal in a solvent to obtain amorphous silicon.

The process according to the invention features particularly high versatility. For instance, it can be used to prepare highly pure amorphous (black) silicon. However, it is likewise possible to prepare brown, coated amorphous silicon, i.e. low-purity amorphous silicon. A further possibility for use of the process according to the invention is that it can be used to alter the coating of the coated amorphous silicon. In other words, it is possible, from coated amorphous silicon which is surface-coated, for example, with O, to prepare coated amorphous silicon which is coated, for example, with Cl. Yet another variant of the process according to the invention features its use to convert crystalline to amorphous silicon. Finally, the process according to the invention also finds use for purifying silicon. Further detail on the above-described embodiments of the process according to the invention will be provided later.

In step b. of the process according to the invention, the silicon tetrachloride prepared is reduced using a metal in a solvent. The term “solvent” used here means a medium which is capable of preparing a dispersion of the metal in the “solvent”, i.e. this term is also intended to include simple dispersions. An apolar or nonpolar “solvent”, in contrast to a “polar” solvent, has no polar groups or functional groups whose characteristic electron distributions impart to the molecule a considerable electrical dipolar moment, so that such groups bring about the affinity for other polar chemical compounds.

In one embodiment of the process according to the invention, a polar solvent finds use in step b. The thus obtained amorphous silicon is obtained as a brown powder and is, as investigations have shown, “surface-coated”, for example with Cl, silyl chloride or O₂ or HO. The use of a polar solvent inevitably achieves surface coating of the amorphous silicon obtained, which is not pure amorphous silicon owing to the surface coating present. An example of such a polar solvent is glycol ether.

In a particularly preferred embodiment of the process according to the invention, an apolar solvent is used in step b. It has been found in accordance with the invention that use of an apolar solvent in the above-specified reduction process provides pure amorphous silicon which has a black color. This amorphous silicon is not “surface-coated” and features particularly high reactivity. Organic, noncoordinating solvents such as xylene, toluene preferably find use.

The metal used in step b. is preferably a metal of group I or II of the Periodic Table. Sodium is preferred, but good results have also been achieved with magnesium.

The metal is preferably melted in the solvent in order to produce a dispersion of the metal in the solvent. Such a melting is not absolutely necessary, but rather metal dusts, metal powder, etc may also be used. It is essential that the metal is in a state having a surface activated for the reaction.

When the metal is to be melted in the solvent, an apolar solvent preferably finds use, whose boiling point is higher than the melting point of the metal used, and operation is affected with a reaction temperature above the melting temperature of the metal (sodium=96° C.) and below the boiling point of the apolar solvent used. It is also possible to work at elevated pressures.

Appropriately, step b. is carried out under reflux conditions for the solvent.

In the process according to the invention, the uncoated amorphous silicon is obtained in a mixture with a metal chloride. Even this mixture, relative to the amorphous silicon, has a very high reactivity, so that it can be used for the desired further reactions. However, the amorphous silicon may also be isolated from the mixture by a separating process, for which any physical or chemical separating processes may be used. For example, physical separating processes such as melting, pressing, centrifuging, sedimentation processes, flotation processes, etc. may be used. The chemical process carried out may be an extractive washing of the amorphous silicon with a solvent or solvent mixture which dissolves the metal chloride but does not react irreversibly with the silicon. For example, liquid ammonia is used to obtain silicon coated with ammonia, and the desired pure amorphous silicon having a black color can be prepared by pumping off the ammonia.

To obtain the silicon tetrachloride, the process according to the invention provides various alternatives. In a first alternative, SiO₂ (silicon dioxide) is reacted with chlorine (Cl₂) in the presence of a reducing agent. The reducing agent may be carbon, in which case the process is referred to as carbochlorination. A corresponding process is described, for example, in EP 0 167 156 A2. The reducing agents used may also be metals. In one embodiment of the process according to the invention, magnesium is used as the reducing agent, in which case this so-called magnesothermic process proceeds by the reaction equation
SiO₂+2Mg→2MgO+Si
This process provides crystalline silicon. When MgO is added, amorphous coated silicon is obtained.

A further process variant is the so-called aluminothermic process in which the reducing agent used is aluminum. The process proceeds as follows:
3SiO₂+4Al→3Si+Al₂O₃
In this process too, crystalline silicon is obtained.

The Si formed is reacted with chlorine to give silicon tetrachloride. In this way, the resulting crystalline silicon can be converted to amorphous silicon (highly pure or coated), or a recoating of amorphous silicon may be carried out. In addition, a purification of the silicon obtained (amorphous or crystalline) may be undertaken when appropriately contaminated SiO₂ is used as the starting material.

In a further alternative of step a. of the process according to the invention, silicon is reacted with chlorine or chlorine compounds. It may be silicon which is to be purified, converted from crystalline into the amorphous state or recoated.

Another variant provides that the silicon tetrachloride is obtained as a by-product of the Müller-Rochow synthesis or of the preparation of chlorosilanes. In the latter case, the silicon tetrachloride is obtained, for example, as a by-product in the preparation of trichlorosilane and the deposition of the polycrystalline Si.

In the direct reaction of silicon with chlorine or chlorine compounds, it is possible to work with microwave energy. Preference is given to using chlorine or hydrogen chloride. Appropriately, nonpulsed microwave energy is used, in which case silicon is used in conjunction with a substance which absorbs microwave energy and transfers thermal energy to silicon, in order to accelerate the reaction.

In a fourth variant of the process according to the invention, the object specified at the outset is achieved by a process for preparing amorphous silicon by reacting SiO₂ or silicates with hydrogen fluoride or a fluoride of a metal of group I or II of the Periodic Table to give SIF₄ with release of H₂O, or of hexafluorosilicates with supply of heat to give SiF₄ and metal fluoride and reaction of the SiF₄ with a metal of the group I or II to give Si and a metal fluoride. In this way, brown amorphous silicon can be prepared.

The SiO₂ (silicon dioxide) base material required for the preparation of SiO₂ may be provided from sources present on the earth (especially desert sand, sea sand). This sand which consists substantially of SiO₂ is, in the first alternative, reacted (externally) directly with hydrogen fluoride (HF), and SiF₄ (silicon tetrafluoride) is driven out by adding sulfuric acid to the hexafluorosalicic acid (H₂SiF₆) which forms.

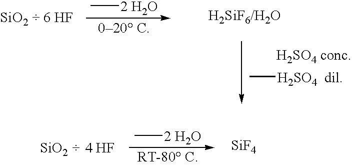

SiO₂ is mixed with HF, and H₂SO₄ is added dropwise with stirring. Depending on the addition rate, SiF₄ is formed between 0° C. and room temperature. A temperature increase to about 80° C. completes the driving-out of SiF₄ from a reservoir vessel. The SiF₄ obtained is a colorless gas which can be further purified by recondensation above its sublimation point (−95.5° C.). All alkali metal fluorides, alkaline earth metal fluorides, aluminum fluorides, etc. forming from impurities of the sand (SiO₂) remain as solid products of the HF reaction or react with H₂SO₄ added to give the sulfates and may be removed as solids (may be sent to product-specific uses after workup).

In the 2^{nd} alternative, sand (SiO₂) is mixed with a fluoride of a metal of group I or II, preferably an alkali metal fluoride (AF), especially sodium fluoride, and sulfuric acid is added dropwise (in situ process). HF is formed in situ and reacts immediately with the SiO₂ to give SiF₄ and metal sulfate, preferably alkali metal sulfate, especially sodium sulfate.

As far as the metal used for the reaction of the SiF₄ is concerned, it may be used in solid or liquid form, or operation is effected in the gas phase. A further alternative provides that the reaction is in solution.

The invention is described specifically hereinbelow with reference to working examples. These examples relate to the first variant of the process according to the invention.

### EXAMPLE 1

### Preparation of Amorphous Silicon from Silicon Tetrachloride

30.20 g (1.31 mol) of Na are melted in 250 ml of o-xylene under protective gas and finely dispersed by vigorous stirring with a magnetic stirrer. 45 ml (62.1 g, 0.365 mol, 1.1 equivalents) of SiCl₄ are added dropwise with vigorous stirring at such a rate that the boiling temperature of the reaction mixture does not go below the melting point of the metal. In order to ensure complete reaction of the sodium, boiling is continued under vigorous stirring and reflux until such time as the boiling temperature of the reaction mixture no longer rises. The result of the reaction is a black mixture of amorphous silicon and NaCl. A large excess of SiCl₄ is not a hindrance to the reaction, as long as the boiling temperature of the mixture remains above the melting point of Na.

### EXAMPLE 2

### Preparation of Amorphous Silicon from Silicon Tetrafluoride

4.15 g (0.18 mol) of Na are melted in 50 ml of o-xylene under an SiF₄ atmosphere and finely dispersed by vigorous stirring with a magnetic stirrer. The reaction temperature is constantly above the melting point of sodium, but below the boiling point of xylene (preferably 110-120° C.). A reservoir of SiF₄ is disposed in a gas balloon attached to the apparatus, with whose aid the SiF₄ conversion is monitored. The reaction is complete as soon as no more SiF₄ is consumed. The product of the reaction is a black mixture of amorphous silicon and NaF.

From the mixture prepared in the two examples above, black amorphous silicon can be obtained by a suitable separation process. The resulting black amorphous silicon has a higher reactivity than silicon obtained in a conventional manner, i.e. with a polar solvent.

The halosilane used may also be hexafluorosilicates.

The reaction temperature above the metal melting point does not apply, for example, to Na dust which also reacts at room temperature. The reaction temperature below the boiling point is only to be maintained for gaseous silanes in order to ensure sufficient particle pressure of the silane over the dispersion and thus achieve acceptable reaction times.

1-27. Cancelled.

28. A process for preparing amorphous silicon particles, comprising:
reducing a halosilane, organohalosilane, salt thereof, or mixture thereof with a metal or metal compound as a reducing agent in an organic solvent,
wherein when the halogen of said halosilane or organohalosilane is Cl, Br, or I, said organic solvent is an apolar organic solvent.

29. The process of claim 28, wherein said halosilane comprises silicon tetrachloride.

30. The process of claim 28, wherein said salt comprises a hexafluorosilicate salt.

31. The process of claim 28, further comprising first preparing by one of the following:
a) where the halosilane comprises SiCl₄,
i) reacting SiO₂ with chlorine in the presence of a reducing agent to form SiCl₄,
ii) reacting silicon with chlorine or a chlorine compound to form SiCl₄; or
iii) separating SiCl₄ from the product of a Müller-Rochow synthesis of chlorosilanes,
b) where the halosilane comprises SiF₄,
i) reacting SiO₂ or a metal silicate with HF or a fluoride of at least one metal selected from the group consisting of the Group 1 and Group 2 metals of the Periodic Table of the Elements to yield SiF₄ and H₂O or
ii) decomposing a hexafluorosilicate metal salt to generate SiF₄ and a metal fluoride.

32. The process of claim 28, wherein a metal is employed as a reducing agent, and said organic solvent is heated to a temperature sufficient to melt said metal.

33. The process of claim 32, wherein said metal in a liquid state and said organic solvent are agitated to form a dispersion of metal.

34. The process of claim 28, wherein said reducing agent comprises at least one metal from Group 1 or Group 2 of the Periodic Table.

35. The process of claim 28, wherein said reducing agent comprises sodium metal.

36. The process of claim 28, wherein said reducing agent comprises a dispersion of a solid metal particles in organic solvent.

37. The process of claim 28, wherein said reducing agent comprises fusible metal, and said organic solvent has a boiling point at the pressure under which the process is conducted which is higher than the melting point of the fusible metal.

38. The process of claim 37 which is conducted at atmospheric pressure.

39. The process of claim 28, wherein said step of reducing comprises reducing under reflux in the organic solvent.

40. The process of claim 28, further comprising separating an amorphous silicon particle product from other reaction components.

41. The process of claim 28, wherein crystalline silicon is a precursor to said halosilane or organohalosilane.

42. A process for purifying silicon metal, comprising supplying impure silicon in the form of silicon metal or a silicon compound, converting said silicon metal or said silicon compound to a halosilane, an organohalosilane, or a hexahalosilicate salt; preparing amorphous silicon by the process of claim 28; and isolating a pure amorphous silicon powder product.

43. A process for preparing an organosilicon compound, comprising:
a) preparing amorphous silicon metal by the process of claim 28;
b) reacting said amorphous silicon metal with one or more organohalogen compounds; and
c) isolating on organosilicon compound.

44. The process of claim 43, wherein said amorphous silicon is in the form of a black amorphous silicon, brown amorphous silicon, or mixture thereof.

45. The process of claim 43, wherein said organosilicon product comprises at least one oganohalisilane.

46. The process of claim 43, wherein said organosilicon compound comprises a methylhalosilane.

47. The process of claim 43, wherein no catalyst for the reaction of amorphous silicon metal with organohalogen compound is present.

48. The process of claim 43, wherein an effective amount of a catalyst which catalyzes the reaction between amorphous silicon metal and organohalogen compounds is present.

49. The process of claim 43, wherein the process is conducted at a temperature below 300° C.

50. The process of claim 43, wherein said amorphous silicon metal is employed in admixture with a metal halide byproduct of the preparation of said amorphous silicon metal.

51. The process of claim 43 which takes place in a fluidized bed comprising amorphous silicon metal particles.

52. The process of claim 43, wherein reaction of amorphous silicon metal particles with organohalogen compound is accelerated by irradication with microwave energy.

53. The process of claim 52, wherein a further substance which absorbs microwave energy and transfers absorbed energy to silicon particles is present.
